(19) United States
(12) Patent Application Publication
(10) Pub. No.: US 2018/0068172 A1
(43) Pub. Date: Mar. 8, 2018

(54) Method of surveillance using a multi-sensor system

(71) Applicant: SAFRAN IDENTITY & SECURITY, Issy Les Moulineaux (FR)

(72) Inventors: Vincent DESPIEGEL, ISSY LES MOULINEAUX (FR); Christelle BAUDRY, ISSY LES MOULINEAUX (FR)

(21) Appl. No.: 15/680,883

(22) Filed: Aug. 18, 2017

(30) Foreign Application Priority Data
Aug. 19, 2016 (FR) 16 57839

(51) Int. Cl. G06K 9/00; H04W 12/08

(52) U.S. Cl. CPC G06K 9/00268; G07C 9/00158; H04W 12/08; G06K 9/00771

(57) ABSTRACT

A method for the surveillance of a place using a network of image sensors connected to a biometric recognition device so arranged as to retrieve biometric features of persons from images supplied by the sensors and to compare the biometric features retrieved from images provided by distinct sensors in order to detect therefrom the presence of the same person according to a score of proximity between the biometric features, with the method comprising the steps of determining positional information and temporal information representing a split time between the two images and checking consistency between the newly determined positional and temporal information and the previously stored positional and temporal information.

The present invention relates to the field of the surveillance of places such as, for instance transport terminals (airports, stations, harbours), military sites, industrial sites, public places . . .

### PRIOR ART

Surveillance systems consisting of a network of cameras distributed over the place to be watched are known.

Such cameras are associated with a recognition device so arranged as to detect the features of persons present on the images captured by the cameras and to compare the detected features with features stored in a data base related with one identifier of the persons which they belong to. This makes it possible, for instance, to follow the movements of a person in the place or to recognize such person if the stored identifier relating to said person comprises information on his/her identity.

### OBJECT OF THE INVENTION

One object of the invention is to improve the performances of such systems.

### BRIEF DISCLOSURE OF THE INVENTION

For this purpose, the invention provides for a method for the surveillance of a place using a network of image sensors connected to a biometric recognition device so arranged as to retrieve biometric features of persons from images supplied by the sensors and to compare the biometric features retrieved from images provided by distinct sensors in order to detect therefrom the presence of the same person. The method comprises the steps of:
determining, on the images, and storing positional information representing at least one position of the persons, whose biometric features have been detected;
when the same person is detected on the images of at least two distinct sensors, determining and storing at least one piece of temporal information representing a split time between the two images
checking consistency between the newly determined positional and temporal information and the previously stored positional and temporal information.

A history of positional and temporal information is thus available and the checking of consistency makes it possible to detect an anomaly in the shooting. Positional information may reveal, for instance: a modification in the behaviour of persons who no longer move the same way within the range of at least one of the sensors, the moving of one of the sensors or an attempted fraud by presenting a small-sized photograph. Temporal information makes it possible to confirm that the person is the same or to show a modification in the persons' behaviour (increase in the persons' moving speed), in the place topography (modification in the possible movements between two sensors by creating or closing a door, for instance): from the stored temporal information, a minimum time between the detection of the features representing one person by a first sensor and the detection of the features representing the same person by a second sensor can be calculated for instance (if the zone covered by the second sensor cannot be physically reached from the zone covered by the first sensor within a predetermined time, a person detected in the zone covered by the first sensor cannot be in the zone covered by the second sensor but when this time has elapsed). A statistical processing of the positional and temporal information can be carried out in order to determine a probability of the actual presence of one person or an object in a given place.

Consistency can be used to validate the detection of a face (is an object detected on the image a face or not?) and/or the recognition of a face (are the biometric features of a face detected on one image similar to those of a face detected on another image?). For example, the detection score is increased (the score representing the proximity of the detected object with a face) if consistency exists between the newly determined positional and temporal information and the previously stored positional and temporal information, and it is decreased otherwise. The same is true for recognition, the recognition score is increased (the score representing the proximity of the face detected on the image with a face detected on another image) if consistency exists between the newly determined positional and temporal information and the previously stored positional and temporal information, and it is decreased otherwise. This can be done by applying a transformation score function, depending on consistency probability. This results in an improvement of the global detection and/or recognition performances.

The recognition of the same person on several images from a texture of the face extracted from the images supplied by the sensors can also be considered.

However, biometric features preferably comprise face characteristic features.

The characteristic features of a face (corners of the eyes, corners of the mouth, points on the nose . . . ) are thus preferably used as biometric features. The recognition of persons is thus improved.

Other characteristics and advantages of the invention will appear upon reading the following description of particular non restrictive embodiments of the invention.

### BRIEF DESCRIPTION OF THE FIGURES

Reference will be made to the appended drawings, among which:

FIG. 1 is a schematic view of a place equipped with a surveillance device for the implementation of the invention;

FIG. 2 is a view of a topography representing the place and usable for implementing the invention.

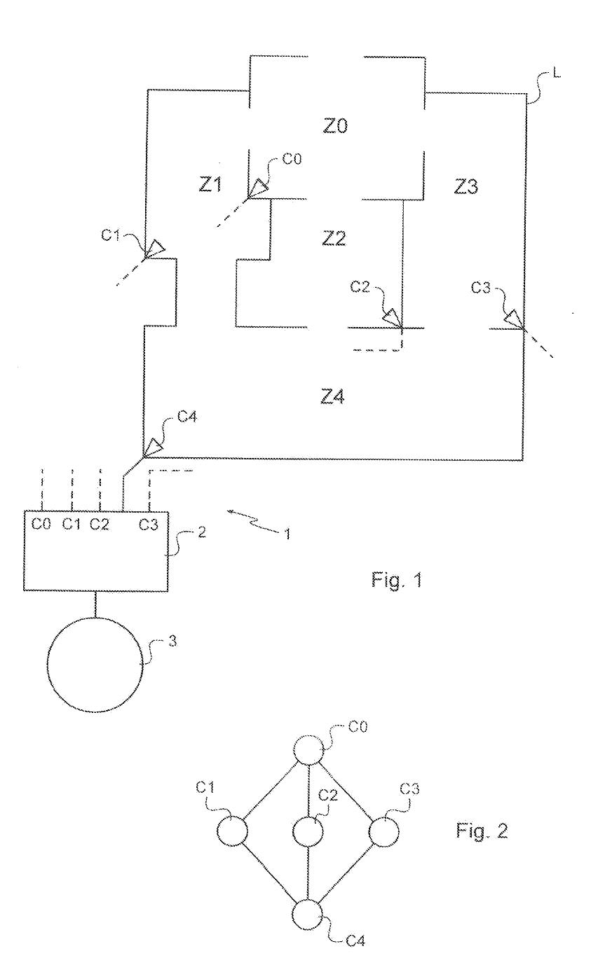

### DETAILED DESCRIPTION OF THE INVENTION

Referring to the figures, the invention is disclosed here when applied to the surveillance of a place L, here a shed, with zones Z0, Z1, Z2, Z3, Z4, forming halls in the place L. The zone Z0 is the entrance hall of the place L and the zone Z4 is the exit hall of the place L. The zone Z0 communicates with the zones Z1, Z2, Z3 on the one hand and with the outside of the place L on the other hand. The zone Z1 communicates with the zones Z0 and Z4. The zone Z2 communicates with the zones Z0 and Z4. The zone Z3 communicates with the zones Z0 and Z4. The zone Z4 communicates with the zone Z1, the zone Z2 and the zone Z3. It should be noted that: the zone Z4 is not directly accessible from the zone Z0 and vice versa; the zone Z3 is not directly accessible from the zone Z1 and vice versa.

Each one of the zones Z0, Z1, Z2, Z3, Z4 is equipped with at least one camera C0, C1, C2, C3, C4 so arranged as to capture images of persons moving in the zones Z0, Z1, Z2, Z3, Z4, with such images having a sufficient resolution for features representing the persons on such images being detectable. Such representative features comprise for example the clothes, the hair-set, all the biometric features among which, specifically, the face lines. In the zone Z0, the camera C1 is preferably positioned close to the entrance, a reception desk or an access control desk, where every person walking into the place L has to go and optionally present at least one document proving his/her identity or an access clearance: an image of any person having regularly entered the place L can thus most certainly be obtained. Similarly, the camera C4 is preferably positioned close to the exit so as to capture images of any person regularly leaving the place L.

The method of the invention is implemented using a biometric recognition and surveillance device, generally noted 1, comprising a computer processing unit 2 which is connected to the cameras C0, C1, C2, C3, C4 and which is so arranged as to process the data transmitted by the cameras C0, C1, C2, C3, C4.

The processing unit executes a computer programme for the surveillance of persons. The programme analyses the images captured by the cameras C0, C1, C2, C3, C4, with such images being transmitted when and as captured.

For each zone, the programme is so arranged as to detect on the images transmitted thereto features representing each person thereon. The representative features are here biometric features and more particularly biometric features of a face. More precisely, the biometric features of a face are the positions of face characteristic features such as the corners of the eyes, the corners of the mouth, points on the nose . . . The programme used here is so arranged as to process each one of the images provided by the sensors so as to retrieve therefrom the positions of such face characteristic features without taking the face texture into account.

The programme is further so arranged as to store such features in association with temporal detection information, a person's identifier and a zone identifier. The temporal detection information makes it possible to determine when (hour, minute, second) the image whereon the representative features have been detected has been captured. Prior to storing the representative features, a step of recognition consisting in comparing such representative features with previously stored representative features so as to determine whether the person detected in said zone has been detected in other zones is executed. The comparison is executed by implementing biometric identification also called [symbol] matching [symbol] techniques by calculating a score of proximity between the biometric features and comparing such score with an acceptance threshold. If the score of proximity between the biometric features detected on an image of a person supplied by the camera C0 and biometric features detected on an image of a person supplied by the camera C1 for example is above an acceptance threshold, the person is considered as the same one.

Thus, if the answer is yes, the newly detected representative features are recorded in association with the pre-existing identifier; if not so, the newly detected representative features are recorded in association with a new identifier here selected arbitrarily. A step of confirmation carried out from a topography of the place by checking consistency of the movement of the person from one zone to another and a temporal model by comparing temporal detection information of the representative features in the zones can be provided for.

Theoretically, the identifiers are created for the persons newly detected on the images captured in the zone Z0 (there is no entry into the other zones) and the identifiers and the associated data are deleted when the persons is detected as leaving the zone Z4.

The processing unit thus makes it possible to automatically follow a person moving in the place L.

In parallel, a checking method is provided for, which makes it possible, from a history of positional information and temporal information determined from images supplied by the cameras C0 to C4, to check the correct processing of this method of surveillance.

Such checking method comprises the following steps, implemented by the processing unit:
determining, on the images, and storing, positional information representing at least one position of the persons whose biometric features have been detected;
when the same person is detected on the images of at least two distinct sensors, determining and storing at least one piece of temporal information representing a split time between the two images;
checking consistency between the newly determined positional and temporal information and the previously stored positional and temporal information.

Several types of positional information are determined here:
according to a first type, positional information represents the location of the zone of the image covered by the persons' faces,
according to a second type, positional information determined from a succession of images filmed by the same camera, represents trajectory of a moving person,
according to a third type, positional information represents the dimensions of the zone of the image covered by the persons' faces.

Of course, other positional information for instance relating to the whole, or a part, of the persons' bodies or silhouettes can be considered.

Temporal information is here the time which has elapsed between the detection of the representative features by the first camera and the detection of the representative features by the second camera.

To determine temporal information, the same person is considered as present on the images of at least two distinct sensors when the score of proximity between the representative features is above a validation threshold which is itself above the acceptance threshold used in the method for surveillance disclosed above. In an alternative solution, using the same threshold could be possible. The score of proximity is preferably a Mahalanobis distance.

If different types of representative features are used (clothes, biometric features . . . ), the score of proximity is calculated by applying weighting to the representative features according to the types thereof.

In an alternative solution, the score of proximity is calculated using different algorithms according to the type of biometric features. Weighting is preferably assigned to each algorithm used for calculating the score of proximity.

Previously stored positional and temporal information which is used for checking consistency has been recorded during a previous recording phase such as a dedicated training phase or a recording phase initiated upon implementing the method and stopped when the volume of collected information is considered as sufficient, as regards statistics. Such previous recording phase of the positional and temporal information makes it possible to build a historic model.

In nominal operation mode, the processing unit determines the positional and temporal information and compares same with that stored during the previous recording phase.

Such comparison is carried out after a statistical processing of the stored information which enabled to calculate an average and a standard deviation for each type of positional information and for temporal information.

As regards the first type of positional information, consistency is checked when the previously determined positional information of the first type is within the average of the stored positional information of the first type, while taking account of the standard deviation. This means that the zone of the image covered by the persons' faces remains located substantially at the same place as seen during the previous recording phase.

As regards the second type of positional information, consistency is checked when the newly determined positional information of the second type is in the average of the stored positional information of the second type, while taking account of the standard deviation. This means that the movement of the persons remains substantially identical with the one noted during the previous recording phase.

As regards the third type of positional information, consistency is checked when the newly determined positional information of the third type is in the average of the stored positional information of the third type, while taking account of the standard deviation. This means that the zone of the image covered by the persons' faces substantially has the same dimensions as noted during the previous recording phase.

As regards temporal information, consistency is checked when the previously determined temporal information is in the average of the stored temporal information, while taking account of the standard deviation. This means that the time of passage from one range of one sensor to another one remains substantially identical with the one noted during the previous recording phase.

Besides, and preferably, the method comprises the step of taking account of the consistency of positional and temporal information to improve the performances as regards accuracy/correctness of the operation of detection and/or the performances as regards accuracy/correctness of the operation of recognition of the persons.

So, in order to improve the detection and/or recognition performances, the method comprises the additional step of modifying detection scores on the basis of the created historical model of detections (Where have the objects been seen? What were their dimensions? . . . ).

Previously stored positional and temporal information make it possible to calculate a probability for a new detection of faces to be present in a position X with a scale S (the positions of the faces detections on the image and the scale associated thereto have been stored, and thus a distribution can be deduced therefrom). Such distribution can be used to modify the score of probability of leaving the algorithm of detection through a multiplication of the two probabilities: the probability associated with the condition observed and the probability for the detection to be a real detection (returned by the detection algorithm). Any function depending on both probabilities can also be used. This makes it possible to give a greater weight to detections consistent with the model learnt and to invalidate inconsistent detections (in short, the same acceptance threshold can be used or not, whether the detections are consistent with the model or not). Erroneous detections are then strictly limited (those which do not correspond to faces) while favouring the detections actually corresponding to faces.

Similarly, previously stored positional and temporal information can be used to weight the matching scores by multiplying the score of probability of consistence with the model (the time discrepancy noted has a probability of occurrence which may be calculated from the model learnt thanks to the stored information) and the score of association between two persons. Any other function depending on such two probabilities can also be used. This makes it possible to similarly improve the biometric performances by penalizing the associations inconsistent with the temporal model (for example: in an airport, one person will very unlikely take 6 hours between the luggage check-in time and the check-in time at the entrance of the boarding zone via the metal detectors) and by favourizing those consistent with the temporal model. This makes it possible to improve the global biometric performances of said system and thus also to improve the model.

Besides, the method comprises the step of emitting a warning when the newly determined positional and temporal information and the previously stored positional and temporal information are not consistent.

Such warning is emitted when a lasting discrepancy between the newly determined positional and temporal information and the previously stored positional and temporal information has been noted, i.e. when such discrepancy lasts for a predetermined period of time.

Such a discrepancy may correspond to:
a modification in the users' behaviour,
a modification in the adjustment of at least one of the sensors,
a modification in the topography of the place.

Such modifications may affect the performances of the method of surveillance and it is important to follow and to check the impact thereof on the performances of the method of surveillance. The warning triggers the action of one operator who will check the existence of a problem there.

After a warning, a new phase of recording positional and temporal information is launched.

It should be noted that positional information may be processed to determine the relative positions of the cameras. This makes it possible, for example, to:
determine whether a camera has moved, for instance further to a mishandling during a maintenance operation, or an incorrect tightening of a bolt which holds it in position,
determine whether a camera has a specific orientation which requires a processing of the images to improve the recognition (for example if a camera is in low angle shot, it is interesting to distort the image to restore the original shapes of the present faces prior to launching a recognition operation).

A temporal follow-up of the performances can also be carried out from such information.

Of course, the invention is not limited to the described embodiments but encompasses any alternative solution within the scope of the invention as defined in the following claims.

More particularly, the method of the invention is applicable to any system of surveillance comprising a network of sensors distributed in a place and connected to a biometric recognition device.

The representative features may also comprise other features in addition to the biometric features and for example features relative to the persons' clothes.

1. A method for the surveillance of a place using a network of image sensors connected to a biometric recognition device so arranged as to retrieve biometric features of persons from images supplied by the sensors and to compare the biometric features retrieved from images provided by distinct sensors in order to detect therefrom the presence of the same person according to a score of proximity between the biometric features, with the method comprising the following steps, implemented by the biometric device of:
determining, on the images, and storing, positional information representing at least one position of the persons, whose biometric features have been detected;
when the same person is detected on the images of at least two distinct sensors, determining and storing at least one piece of temporal information representing a split time between the two images;
checking consistency between the newly determined positional and temporal information and the previously stored positional and temporal information.

2. The method according to claim 1, comprising the step of taking account of the consistency of the positional and temporal information so as to improve the performances as regards accuracy/correctness of the operation of detection and/or the performances as regards accuracy/correctness of the operation of recognition of the persons.

3. The method according to claim 2, wherein taking into account the consistency comprises a phase of calculating, from the previously stored positional and temporal information, a probability for a new detection of a face to be present in a position with a scale on an image.

4. The method according to claim 2, wherein the scores of proximity are weighted according to the previously stored positional and temporal information so as to take account of the consistency of the positional and temporal information.

5. The method according to claim 1, comprising the step of emitting a warning when the newly determined positional and temporal information and the previously stored positional and temporal information are not consistent.

6. The method according to claim 5, wherein the warning is launched after a lasting discrepancy has been noted between the newly determined positional and temporal information and the previously stored positional and temporal information, i.e. such discrepancy lasts for a predetermined period of time.

7. The method according to claim 5, wherein the previously stored positional and temporal information used for checking consistency have been recorded during a previous recording phase and, in case of warning, a new phase of recording positional and temporal information is launched.

8. The method according to claim 1, wherein the temporal information is determined and stored only when the score of proximity is above a predetermined threshold.

9. The method according to claim 1, wherein the positional information is determined according to the zone of the image covered by the persons' faces.

10. The method according to claim 9, wherein the positional information is determined according to the position of said zone on the image.

11. The method according to claim 9, wherein information positional is determined according to the dimensions of said zone on the image.

12. The method according to claim 1, wherein the score of proximity is a Mahalanobis distance.

13. The method according to claim 1, wherein several types of biometric features are retrieved from the images.

14. The method according to claim 13, wherein the score of proximity is calculated while applying weighting to the biometric features according to the type thereof.

15. The method according to claim 13, wherein the score of proximity is calculated using different algorithms according to the type of biometric features.

16. The method according to claim 15, wherein weighting is applied to each algorithm used for calculating the score of proximity.

17. The method according to claim 1, wherein the biometric features comprise points characteristic of the face.
